(19) United States
(12) Patent Application Publication
(10) Pub. No.: US 2005/0261963 A1
(43) Pub. Date: Nov. 24, 2005

(54) Pricing for promotional product

(75) Inventors: Gerald McLaughlin, San Mateo, CA (US); Satyanarayan Belur, San Jose, CA (US); Timothy Scott Freeman, Sunnyvale, CA (US)

Correspondence Address: SCHWEGMAN, LUNDBERG, WOESSNER & KLUTH, P.A., P.O. BOX 2938, MINNEAPOLIS, MN, 55402-0938, US

(73) Assignee: Branders.com

(21) Appl. No.: 11/133,497

(22) Filed: May 19, 2005

Related U.S. Application Data
(60) Provisional application No. 60/573,176, filed on May 20, 2004.

(51) Int. Cl. G06F 17/60

(52) U.S. Cl. 705/14

(57) ABSTRACT

A method to calculate a purchase price automatically for a promotional product captures reference data for a promotional product, and stores the reference data in a database. An electronic request for a purchase price for the promotional product is received, via a communications network, from a purchaser. The purchase price for the promotional product is automatically calculated utilizing the reference data. The reference data may be specified and predetermined reference data as published for the promotional product within a catalog issued by a provider of the promotional product. A customer may request multiple purchase prices from multiple distributors, each distributor then being requested to base a quoted purchase price on the specified and predetermined reference data.

### CLAIM OF PRIORITY

The present application claims priority to provisional application no. 60/573,176 filed May 20, 2004, which is incorporated herein by reference.

### TECHNICAL FIELD

The present application relates generally to the field of product pricing and, in one example embodiment, to a method and system to calculate a purchase price automatically for a promotional product.

### BACKGROUND

The sale of promotional products, also called advertising specialties, has traditionally been practiced as a broker-customer relationship where a commissioned broker presents various lines of products and decoration choices to a customer. For example, a customer may call a broker in connection with a promotion of the customer's company (e.g., a client appreciation golf tournament). The broker will present the customer with a choice of products (e.g., hats, shirts, mugs, etc.) that can be decorated utilizing one of a number of decoration technologies (e.g., embroidery, silk-screen, printing, etc.). The customer may, for example, select a golf shirt, onto which a logo of the relevant company can be embroidered. The broker then coordinates activities between a product vendor or manufacturer, a decorator and the customer to ensure that an order for the relevant promotional product is completed to the satisfaction of the customer.

FIG. 1 is a block diagram providing a diagrammatic representation of an example supply chain 10 for promotional products. The supply chain 10 includes suppliers 12 and customers 16, with distributors (or brokers) 14 providing the interface between the suppliers 12 and the customers 16. As shown in FIG. 1, the suppliers 12 may include manufacturers 18 that manufacture a base product (e.g., a mug or a T-shirt), re-sellers that purchase and resell base products, decorators 20 that decorate base products (e.g., print or embroider, etc.), and integrated manufacturer decorators 22 that both manufacture base products and apply decorations to such base products.

FIG. 1 also illustrates that each distributor 14 of a number of distributors may source products and/or services from one of a number of suppliers 12. Each of the suppliers 12 typically publishes a catalog of products and services available from the relevant supplier 12. These catalogs are then provided to the distributors 14, who in turn show these catalogs to customers 16 to assist with their purchases of promotional products. These catalogs typically include a plurality of products, the prices of which often vary significantly among the products. Consequently, the price for a promotional product order is indeterminable from the catalog without specifying the product to be ordered.

These catalogs typically include per unit prices for the undecorated products. The catalog typically provides many prices per unit for each of the undecorated products. The per unit price for any given undecorated product usually varies significantly depending on the quantity ordered in each order. Consequently, the price for a promotional product order is indeterminable from the catalog without specifying the quantity to be ordered.

These catalogs also typically include formulas, incorporating a plurality of variables, used to calculate a decoration charge. These variables include such data as the number of units to be decorated, the number of colors to be used in the decoration, the size of the decoration, and the technique to be used in applying the decoration. Consequently, the price for a promotional product order is indeterminable from the catalog without specifying a plurality of variables, including the quantity to be ordered and the decoration (for example, a logo and text message) to be applied.

These catalogs also typically include formulas, incorporating a plurality of variables, used to calculate packaging or fill charges. These variables include such data as the number of units to be packaged or filled and the type of packaging or fill to be used. Consequently, the price for a promotional product order is indeterminable from the catalog without specifying a plurality of variables, including the quantity, packaging, and fill to be ordered.

At the time an order is about to be placed, customers wanting to compare prices from multiple distributors can specify the requirements on a particular order and solicit firm quotes on the order as specified. Corporate purchasing departments, however, often face a more difficult problem when evaluating distributor pricing. Corporations often want to consolidate their purchasing of promotional products with a single distributor 14 in order to achieve volume-based pricing efficiencies. Within a corporation, a purchaser (or purchasing department) 17 is typically responsible for selecting that distributor 14. In making this selection, the purchasing department will evaluate the expected costs of acquiring its promotional products from a number of competing distributors 14. However, this evaluation is difficult because, at the time of selection and contracting, the purchasing department typically does not know what particular products, quantities, decoration, packaging, fill or other services the corporation will require during the term of the contract. The distributor and purchasing department also do not know what new products and services will appear in new catalogs introduced during the term of the contract.

Because actual prices cannot be negotiated, distributors and purchasing departments typically negotiate and agree upon a method of calculating promotional products prices, this method to be applied in the future when a specific product and decoration combination is ordered.

Currently, such contracts between customers 16 and distributors 14 frequently take one of two approaches, namely (1) a “market basket” approach, or (2) a “cost plus” approach. Under the “market basket” approach, the customer 16 will provide distributors 14 with a list of promotional products that the customer 16 believes it may order under the contract at some future date. Each distributor 14 is asked to quote firm prices on the listed promotional products. This is an attempt to address the above-identified problem of the customers 16, and specifically a purchaser 17, not knowing with sufficient certainty which promotional products may be ordered under the contract in the future. However, it would be appreciated that few customers 16 have any real way of predicting what promotional products (including decoration) may be ordered in the future. Promotional products as specified on the “market basket” list typically represent a small percentage of promotional products that will be ordered during the life of the contract. Accordingly, distributors 14 are tempted to provide very low price quotes for “market basket” promotional products, but then to recoup profits on orders for promotional products that fall outside the “market basket” list. Simply put, the “market basket” approach itself does not give the customer 16 much control of the costs of orders that fall outside the “market basket” list.

Turning now to the “cost plus” approach, a problem with this approach is that distributors 14 do not have a uniform cost structure. Accordingly, while a particular distributor 14 may offer to provide promotional products at a specified gross margin or mark-up, it is difficult to evaluate whether the gross margin or mark up offered by one distributor is better than that offered by another because the base costs, to which the gross margin or mark up will be added, typically vary among distributors. Consequently, the lowest gross margin or mark up being offered frequently will not yield best price to a customer 16 because the specific distributor offering the lower gross margin or mark up 14 may have costs that are higher than those of another distributor 14. Further, as “cost plus” contracts frequently are written as a percentage of costs, such contracts create a disincentive to the distributor 14 to manage costs. For example, a distributor 14 may not resist a price increase from a supplier 12 because the price increase is passed to the customer 16. The distributor 14 may even earn more as a result of the higher cost if, for example, the distributor 14 and the customers 16 have agreed that the customer's 16 price will be the distributor's cost, plus an agreed-upon percentage.

### SUMMARY OF THE INVENTION

According to one aspect, there is provided a method to contract for a purchase price for a promotional product, where the promotional product is unspecified at the time of contracting. A purchaser and a distributor agree that the purchase price for the unspecified promotional product will be calculated, at the time of an order, based on reference data in the example form of a reference price (or pricing) for the as yet unspecified promotional product. The reference data may be identified as being a particular price or prices to be published within a promotional product catalog issued by a supplier of the promotional product, or any other publicly available price (or determinable information utilizing which a price for a promotional product may be calculated). For example, the reference pricing may be derived from an agreed-upon formula and data set (e.g., an average of a selected group of published tiered prices)

According to a further aspect, there is provided a method to calculate a purchase price automatically for a promotional product. Reference data for a promotional product is electronically captured, and stored in a database. An electronic request for a purchase price for the promotional product is received, via a communications network, from a requester. The purchase price is automatically calculated for the promotional product based on the reference data. The reference data may be specified for the promotional product with reference to a catalog of a supplier of the promotional product. According to an even further aspect, there is provided a method to establish an agreement regarding a purchase price for a promotional product to be specified (or identified) at a future date. A source from which reference data for the promotional product will be determinable at the future date is identified. A purchase price for the promotional product is specified based on the reference data as determinable from the source at the future date. The specification of the purchase price for the promotional product, based on the reference data, is communicated to a third party.

One aspect also extends to a method to solicit bids for a promotional product from a plurality of distributors. This method includes providing an identifier for reference data (e.g., a promotional product catalog identifier) to each of the plurality of distributors. Each of the plurality of distributors is requested to provide a formula according to which a purchase price for the promotional product would be calculated, based on the reference data, at an unspecified future time.

Another aspect includes a method automatically to calculate a purchase price for a promotional product. In advance of a price calculation operation, reference data for the promotional product is electronically captured, and store in a database, a source of the reference data having been identified and agreed to by a distributor and a customer, in advance of the capturing of the reference data. In advance of the price calculation operation, a formula to calculate the purchase price (based at least partially on the reference data) is electronically captured, the formula having been identified and agreed to by the distributor and the customer, in advance of the capturing of the formula. An electronic request for the purchase price for the promotional product is received, via a communications network, from a requester. The purchase price for the promotional product is automatically calculated utilizing the reference data and the formula.

Other features will be apparent from the accompanying drawings and from the detailed description that follows.

### BRIEF DESCRIPTION OF THE DRAWINGS

An embodiment of the present invention is illustrated by way of example and not limitation in the figures of the accompanying drawings, in which like references indicate similar elements and in which:

FIG. 1 is a block diagram providing a diagrammatic representation of a supply chain for promotional products, existing within the prior art.

FIG. 2 is a block diagram illustrating an example networked environment within which an embodiment of the present invention may be implemented.

FIG. 3 is a block diagram illustrating architectural details regarding a pricing engine, according to an example embodiment of the present invention, as well as various tables that may be maintained within a database that supports functioning of the pricing engine.

FIG. 4 is a block diagram illustrating details regarding information that may be maintained within various tables of the database illustrated in FIG. 3.

FIG. 5 is a diagrammatic representation of a page from a catalog of a supplier, and illustrates information that is typically available within such a catalog.

FIG. 6A and 6B show a flowchart illustrating a method, according to an example embodiment of the present invention, to calculate a purchase price automatically for a promotional product.

FIG. 7 is a diagrammatic representation of an audit report, according to an example embodiment of present invention, which may be generated by a distributor that operates a network-based distributor platform.

FIGS. 8-11 illustrate a series of the user interfaces, according to an example embodiment of present invention, which a network-based distributor platform may communicate to a client machine for display by a client application.

FIG. 12 is a flowchart illustrating a method, according to an example embodiment of the present invention, to compare purchase prices received from a number of distributors.

FIG. 13 is a diagrammatic representation of a machine, in the example form of a computer system, within which a set of instructions may be executed for causing the machine to perform any one or more of the methodologies described herein.

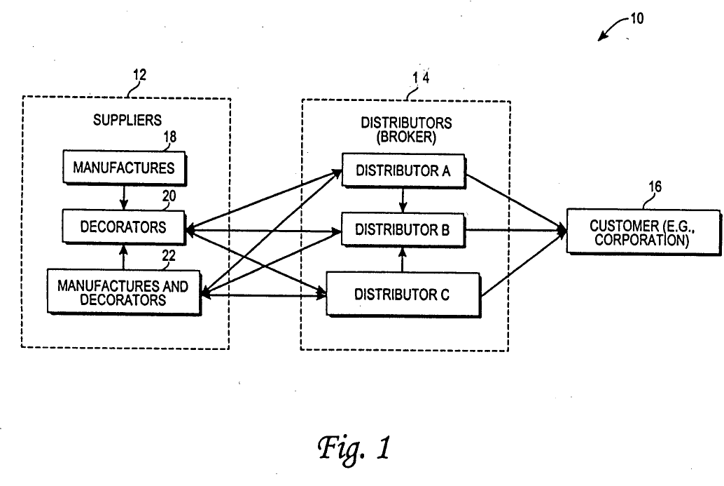

### DETAILED DESCRIPTION

A method and a system to calculate a purchase price automatically for a promotional product are described. In the following description, for purposes of explanation, numerous specific details are set forth in order to provide a thorough understanding of an embodiment of the present invention. It will be evident, however, to one skilled in the art that the present invention may be practiced without these specific details.

For the purposes of the present document, the term “promotional product” shall be taken to include any product or service that is made available by a manufacturer or distributor for use in a promotional manner, and shall be taken to include products to which a custom decoration is or may be applied, and other pre-decorated or undecorated products that are made available for promotional purposes.

Reference data may refer to any publicly available data, or determinable information, utilizing which a price for an promotional product may be calculated. For example, the reference data may be derived from an agreed-upon formula and data set. Further, the reference data, and possibly the manner in which the reference data is calculated, may be different for different promotional products and for different purchasers.

In one example embodiment, the present invention seeks to address the problem, identified above, that results from the separation of a purchaser 17 from a requisitioner 19 within a corporate customer 16, and the desirability of negotiating price for unspecified promotional products. At a high level, one aspect of the present invention seeks to provide a mechanism whereby a purchaser 17 of promotional products, for example, is able to evaluate contract offers from multiple distributors 14 in a meaningful manner. This meaningful comparison is facilitated in that a purchase price for an unspecified promotional product is specified, in each of multiple contract offers, in terms of reference data (e.g., reference pricing) that will be known to both the customer 16 and the distributor 14 when an order for the unspecified promotional product may be placed at some future date. In this way, a purchaser 17 is able to make a meaningful comparison between various contract offers, as each of these contract offers will express a purchase price for the unspecified promotional product based on common reference data.

One example embodiment of a system to facilitate the above-described mechanism is a described below. The provision of the mechanism is not a dependent upon the existence of such a system, and the described system is intended to be an unlimiting example of a technology infrastructure that may underlie the mechanism.

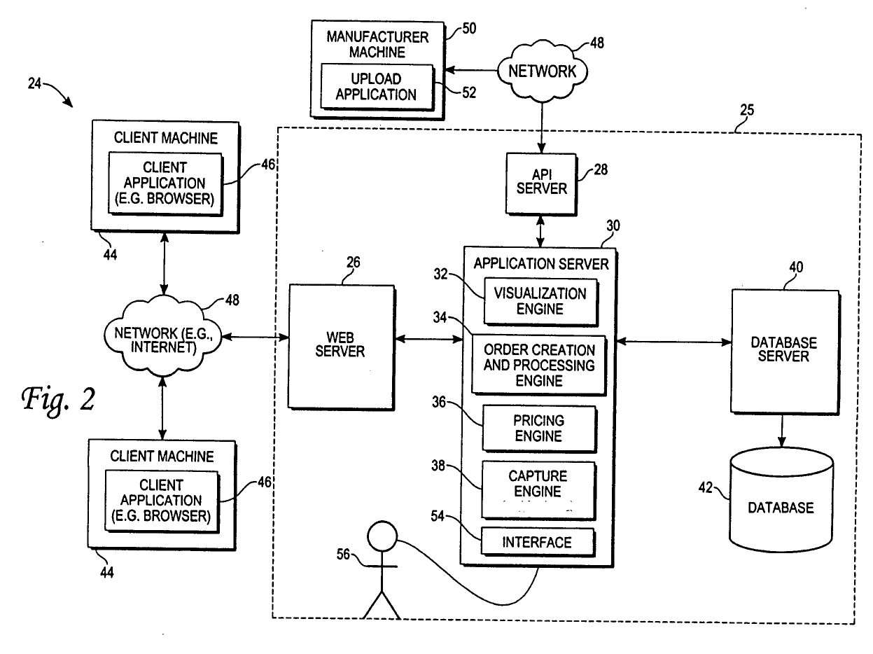

FIG. 2 is a block diagram illustrating a networked environment 24 within which an example embodiment of the present invention is implemented. The example networked environment 24 illustrated in FIG. 2 is a client-server environment. However, the present invention need not be deployed in a network environment, and could be implemented as part of a stand-alone software program or package.

In one embodiment, a server side of the networked environment is a network-based distributor platform 25, operated by a distributor 14 so as to provide customers 16 of the distributor 14 with a network-based service for the placement of orders for promotional products and for the management of a relationship between a distributor 14 and a customer 16. Of course, the present invention is not limited to a distributor platform 25, and this platform 25 merely provides an example context within which one embodiment of the present invention is described. Turning to the example network-based distributor platform 25, a web server 26 and an Application Program Interface (API) server 28 are each coupled to, and facilitate access to, an application server 30, which hosts a number of applications, application components and/or application modules. Specifically, the application server 30 is shown to host a visualization engine 32, an order creation and processing engine 34, a pricing engine 36 and a capture engine 38. The application server 30 in turn is coupled to a database server 40 that provides access to a database 42. The database 42, as will be described in further detail below, includes a number of tables storing data that is utilized by the various engines 32-38 that execute on the application server 30.

On the client side of the networked environment 24, multiple client machines 44 each host a client application 46 that communicates with the network-based distributor platform 25 via a network 48 (e.g., the Internet). A client application 46 may be a browser application (e.g., the Microsoft Internet Explorer (IE) browser) or a dedicated client application (e.g., a dedicated purchasing application) that interacts with the network-based distributor platform 25. Further, while the client applications 46 are shown in FIG. 2 to access the network-based distributor platform 25 via the web server 26, these client applications 46 may also access the network-based distributor platform 25 via the API server 28.

FIG. 2 also shows a manufacturer machine 50 (e.g., a computer system deployed by a supplier 12) as being coupled to, and accessing, the API server 28 via the network 48. The manufacturer machine 50 hosts an upload application 52 to upload reference data in the example form of reference pricing information (e.g., catalog price information). For example, the manufacturer may upload catalog information, regarding the promotional products manufactured and or sold by the relevant supplier 12, to the network-based distributor platform 25. The capture engine 38 may operate to facilitate the upload and capture of the catalog information, and also attends to the storage of the relevant catalog information, including catalog price information, within the database 42.

The visualization engine 32 is responsible, in one example embodiment of the present invention, for generating composite images to represent promotional products. Specifically, the visualization engine 32 has access to base produce images and decoration images stored within the database 42. The visualization engine 32 further allows a user, for example utilizing a client application 46, to create a composite image that depicts the application of a particular decoration to a particular base product so as to enable a user to preview a promotional product visually prior to placing an order. The visualization engine 32 is furthermore able to determine specifications (e.g., base product and decoration specifications) for a promotional product from input provided by a user during the creation of a composite image. For example, during creation of a composite image representing a promotional product, a user will specify a base product, decoration method, imprint area, quantity, number of decoration colors, etc., each of which may be recognized by the visualization engine 32 and provided to the pricing engine 36 for utilization in the calculation a sales or quote a price for a particular promotional product.

The order creation and processing engine 34 is responsible for the final order creation, back-end processing and auditing of orders.

The capture engine 38 electronically captures catalog information, including catalog price information, for promotional products offered by a range of suppliers 12. In one embodiment, the capture engine 38 may interact with an upload application 52, executing on a manufacturer machine 50, to upload catalog information to the application server 30, and to store such catalog information in the database 42. In an alternative embodiment, the capture engine 38 may provide a convenient interface 54 to a user 56 who is tasked with manually extracting and inputting information from catalogs of various suppliers 12. In this way, the capture engine 38 may facilitate the electronic capture of catalog information that is manually inputted by a user 56.

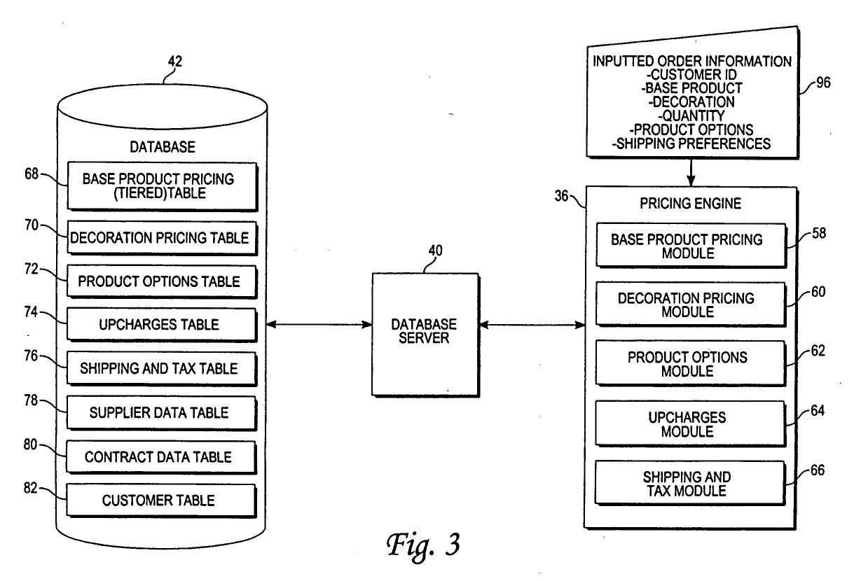

FIG. 3 is a block diagram providing further details regarding an example embodiment of the pricing engine 36, as well as various tables that may be maintained within the database 42 to support operations of the pricing engine 36.

The pricing engine 36 is shown to include a base product pricing module 58, a decoration pricing module 60, a product options module 62, an upcharges module 64, and a shipping and tax module 66. The base product pricing module 58 is, as will be described in further detail below, responsible for calculating a sales, or quote, price for a base product (e.g., shirt, mug, etc.) for a promotional product. The decoration pricing module 60 is responsible for calculating the sales, or quote, price of decorations (e.g., imprints, embroidery, etc.) that are applied to the base product in the manufacture of the promotional product. The product options module 62 calculates purchase price components for options (e.g., material upgrades, accessories etc.) that may be available in connection with a particular base product. The upcharges module 64 is responsible for calculating upcharges (e.g., price increases for a particular product that may result from size increases in a base product) with respect to a promotional product. The shipping and tax module 66 is responsible for the calculation of shipping and tax charges that may be applicable to a specific promotional product.

The database 42 is shown to include a number of pricing tables corresponding to the modules of the pricing engine 36. Specifically, the database 42 is shown to include a base product pricing table 68, a decoration pricing table 70, a product options table 72, an upcharges table 74, and a shipping and tax table 76. Additionally, the database 42 is shown to include a supplier data table 78, a contract data table 80, and a customer table 82.

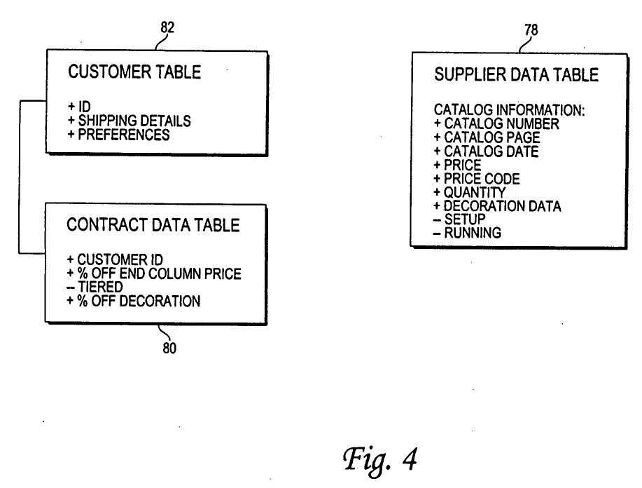

FIG. 4 is a block diagram providing further details regarding information that is maintained within each of the tables 78, 80 and 82. The supplier data table 78, in the example embodiment, stores catalog information extracted from catalogs (e.g., printed or electronic) published by various suppliers 12. The catalog information stored within the supplier data table 78 may, as described above with reference to FIG. 2, may be electronically captured either by the uploading of catalog information from an electronic source, or by manual input. The catalog information that is stored within the supplier data table 78 may include, for each promotional item within a particular catalog, a catalog number identifying a particular supplier catalog, a page within a particular catalog on which details of the relevant promotional product appear, a catalog date, price information for the promotional product, a price code, quantity information, and decoration data, including set up and running cost data.

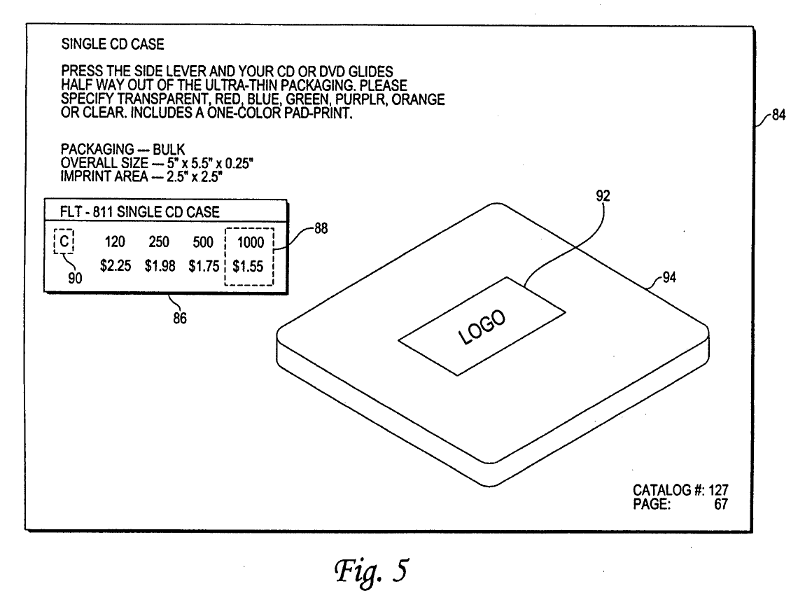

FIG. 5 is a diagrammatic representation of a page 84 from a catalog of a supplier 12, and illustrates information that may be available within a catalog. The information displayed on page 84 includes tiered pricing information, which is tiered based on the quantity of promotional products within a particular order. The pricing information 86 is also shown to include End Column Price (ECP) 88, which represents the lowest catalog per unit product price, based on a number of promotional products included within an order. The ECP 88 is also often referred to as the End Quantity Price (EQP), and the acronyms ECP and EQP are used interchangeably within this document. The pricing information 86 also includes a price code 90, which represents a discount on the published price that a supplier 12 typically provides to a distributor 14. It should be noted that the pricing information 86 may also reflect margins that vary by volume. Accordingly, the price code 90 enables suppliers 12 to service a network of distributors 14 and customers 16 utilizing a common catalog. Distributors 14 have knowledge of what various price codes 90 represent, and will accordingly be able to calculate distributor margins on the sale of a particular promotional product. The page 84 also includes a textual description of the relevant promotional product, and also details regarding a decoration to be applied to the base product. For example, the example page 84 provides details of the overall size and imprint area of a logo 92 to be applied to a promotional product 94.

Returning to FIG. 4, the customer table 82 includes a unique identifier, shipping details and preferences for a particular customer of a distributor operation that operates the network-based distributor platform 25.

The contract data table 80 contains information regarding contracts between a distributor 14 operating the network-based distributor platform 25 and customers 16 of the relevant distributor 14. Specifically, each entry of the contract data table 80 includes a customer identifier, a value representing a percentage discount off an End Column Price (ECP) 88 that the relevant distributor 14 has agreed to provide to the relevant customer 16, and a value indicating a percentage discount off a decoration price, as calculated using formulas and prices described in the catalog, that the relevant distributor 14 has agreed, in terms of the contract, to provide to customer 16. Each of a number of distributors 14 may, for example, be requested to provide a formula, according to which a purchase price for the promotional product would be calculated, based on the reference data, at an unspecified future time.

In one embodiment, multiple percentage discounts off the ECP 88 may be provided on a tiered basis, with the percentage increasing according to an agreed volume or value tiering level. Specifically, the percentage discount provided on the ECP 88 is negotiated between the distributor 14 and the customer 16 and, in one embodiment of the present invention, may be applied to all purchases of promotional products by the customer 16 through the distributor 14. Similarly, the percentage off a decoration price, as calculated using formulas and prices described in the catalog, may be applicable to the purchase of all promotional products by the customer 16 through the distributor 14.

Returning briefly to FIG. 3, the pricing engine 36 is also shown to receive inputted order information 96, which is provided by a customer 16 to a distributor 14 for the purposes of enabling the distributor 14 to provide sales or quote pricing data to the customer 16. The inputted order information 96 includes, for example, a customer identifier identifying the customer 16, base product information identifying a base product for the promotional product, decoration information specifying the details of a decoration to be applied to the base product, quantity information indicating a quantity of promotional products to which the order or quote pertains, product option information identifying product option selections or preferences of the customer 16, and shipping preference information. The inputted order information 96 may be received as part of an electronic request for a purchase price for a particular promotional product. In one example use scenario, the order information 96 may form part of an order request (e.g., a phone, email or web-based order for one or more promotional products). In another example use scenario, the order information 96 may be information that is included in a Request For Quotation (RFQ). In either use scenario, the pricing engine 36 operates to calculate purchase price information that is then either communicated back to the customer 16 for informational purposes, or may be utilized to charge an account of a customer 16 in connection with the purchase of promotional products.

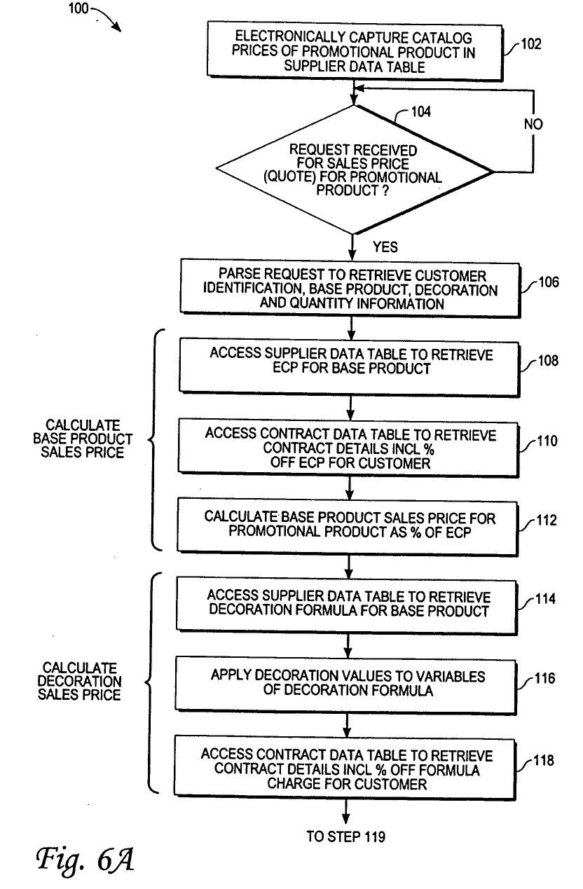

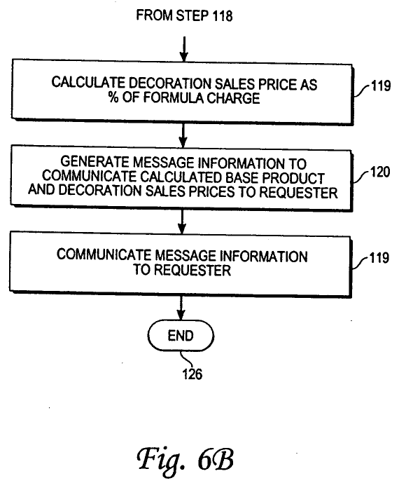

FIGS. 6A and 6B show a flowchart illustrating a method 100, according to an example embodiment of the present invention, to calculate a purchase price automatically for a promotional product. As mentioned above, this calculation may be performed as part of determining a charge in connection with an order for a promotional product, in connection with providing a price quote in connection with a promotional product, or in connection with an audit process to audit historical prices in connection with the orders for promotional products.

The method 100 commences at block 102 with the electronic capture of catalog price information for promotional products in the supplier data table 78. As stated above, this electronic capture of the catalog prices may be performed by way of an upload of catalog information from a supplier 12 to the network-based distributor platform 25 operated by a distributor 14. Alternatively, a distributor 14 may have a user 56 manually input information contained in printed catalogs into the capture engine 38, utilizing the interface 54. The captured catalog price information, in one embodiment, includes two components, namely a base product price component (e.g., the tiered pricing information 86) and a decoration price component, which may be expressed by one or more formulas or guidelines published in a catalog of a specific supplier 12. Other catalog price information that may be captured includes product options, pricing information and shipping and tax information. Further, at block 102, catalog information included within the supplier data table 78, described above with reference to FIG. 4, may also be electronically captured and stored within the database 42.

At decision block 104, a determination is made as to whether a request for a purchase price (e.g., a quote) for a promotional product is received. This request may be received from a quotation process or from a charge process initiated by the order creation and processing engine 34.

On receipt of a request for a purchase price for a promotional item, at block 106, the pricing engine 36 parses the request to retrieve customer identification, base product, decoration, quantity, timing, and delivery information. In one embodiment, wherein the request for purchase price includes a visual specification of a promotional product (e.g., a composite image and associated input information received from a customer 16), the pricing engine 36 may parse this visual product specification information and extract the above-identified information therefrom.

At block 108, the base product pricing module 58 of the pricing engine 36 accesses the supplier data table 78 to retrieve an End Column Price (ECP) 88 for the base product.

At block 110, the base product pricing module 58 accesses the contract data table 80 to retrieve contract details between the relevant distributor 14 and the customer 16. Specifically, at block 110, the base product pricing module 58 may issue a request, via the database server 40, which includes the customer identification information extracted at block 106. The contract details that are accessed at block 110 include, inter alia, a percentage value representing the percentage off the ECP 88 that the relevant customer 16 is entitled to in terms of the contract with the distributor 14.

At block 112, the pricing engine 36 calculates a purchase price for the relevant promotional product utilizing the reference pricing information. For example, the pricing engine 36 may calculate the purchase price by deducting the percentage off the ECP 88, determined at block 110, from the ECP 88. Of course, the pricing engine 36 may, in other embodiments, calculate the purchase price in any of a number of ways, and by applying any of a number of formulas, which utilized a specified reference pricing.

Having now calculated a base product purchase price at blocks 108-112, the method 100 proceeds to blocks 114-118, where a decoration purchase price is calculated for the promotional product. Specifically, at block 114, the pricing engine 36 accesses the supplier data table 78 to retrieve a decoration formula, originally captured from an appropriate catalog, for the base product and the specified decoration.

At block 116, the pricing engine 36 proceeds to apply decoration values, determined at block 106, to variables of the decoration formula in order to calculate a decoration charge.

At block 118, the pricing engine 36 accesses the contract data table 80 to retrieve contract details applicable to the specific customer 16, these contract details including a percentage off a decoration charge.

At block 119, the pricing engine 36 then calculates a decoration purchase price by subtracting the percentage off decoration charge determined at block 118 from the decoration charge calculated at block 116.

Having now calculated the base product purchase price and the decoration purchase price, the method 100 proceeds to block 120, where the pricing engine 36 generates message information to communicate the calculated base product and decoration purchase prices to the requester, from whom the request was received at decision block 104.

At block 124, the generated message information is communicated to the requester. The message may also be communicated to an e-procurement system. In one embodiment, this message information may be included within a generated mark-up language document (e.g., an HTML document) that it communicated to a client machine 44 for display by a client application 46 to a customer. In an alternative embodiment, the message information may be included within an email, Instant Message (IM), Short Message Service (SMS) message or any other message type for communication to the requester.

The method 100 then terminates at termination block 126.

The various accesses to the tables of the database 42 that are described above with reference to FIG. 6 are, in the example embodiment to the present invention, made by the application server 30 to the database server 40, which then responds with appropriate information. In one embodiment, the access requests to the database may be SQL queries.

It will be noted that the above-described example method 100 utilizes the ECP 88 as a predetermined reference pricing to which a discount value is applied. However, in alternative embodiments of the present invention, any catalog price appearing in a catalog for a specific promotional product may be utilized as a predetermined reference pricing to which a discount is applied. For example, certain product catalogs from suppliers 12 may include only a single column, in which case catalog prices contained within that single column would be utilized. In an alternative embodiment, a catalog price from any specified column within a catalog may be utilized in the calculations found above.

Further, the discounting of the predetermined catalog price has been described above as being a percentage discount. In alternative embodiments, the discount may be calculated in other ways. For example, a predetermined dollar value could be deducted from a predetermined catalog price. The reference pricing may of course also be some price other than the ECP 88.

The above-described method 100 for the calculation of a purchase price differs from the “market basket” approach and the “cost plus” approach described above in that the purchase price for a promotional product is calculated based on, or utilizing, a predetermined reference pricing as published in a catalog, and in one embodiment, is agnostic with respect to the quantity of promotional products purchased.

In an alternative embodiment, the calculation of the base product purchase price as performed in blocks 108-112 may implement a predetermined tiered price structure, where the percentage off the ECP 88 may be tiered dependent upon the quantity of promotional products purchased, or the value of the promotional products purchased, for example. A greater percentage off the End Column Price may be extended to the customer where the number of promotional products purchased exceeds a predetermined threshold. In this case, the accessing of the contract data table 80 at block 110 would involve providing quantity information, parsed at block 106, to the database server 40 for inclusion within an access request to the database 42.

The method 100, described above with reference to FIGS. 6A and 6B, is advantageous in that it allows a customer 16 to request that multiple distributors 14 employ the method 100 in the calculation of purchase prices for quotes delivered from the multiple distributors 14 to the customer 16. For example, by specifying a predetermined reference pricing for a promotional product with reference to a specific catalog, and through requiring multiple distributors 14 to calculate a purchase price based on, or utilizing, the predetermined reference pricing, customers 16 are empowered to perform an “apples-to-apples” comparison between quoted purchase prices from multiple distributors 14. The method 100 is also advantageous in that it provides little opportunity to a distributor 14 to vary pricing, because the predetermined reference pricing, as published within a catalog, is the basis for the purchase price quotation and is available to be audited by customers 16. A customer 16 is also placed in a position to perform a compliance audit without the co-operation or knowledge of a distributor 14, thus relieving the customer 16 of any dependence upon a distributor 14 with respect to a compliance audit process. A further benefit is that parties (e.g., a distributor and/or a customer) may have a pricing agreement for products that have not yet been introduced into a market. When new products do appear in a catalog, for example, the parties are clear regarding the price to the customer. It is also advantageous that the price can be agreed to without specifying a supplier of a product or a decoration.

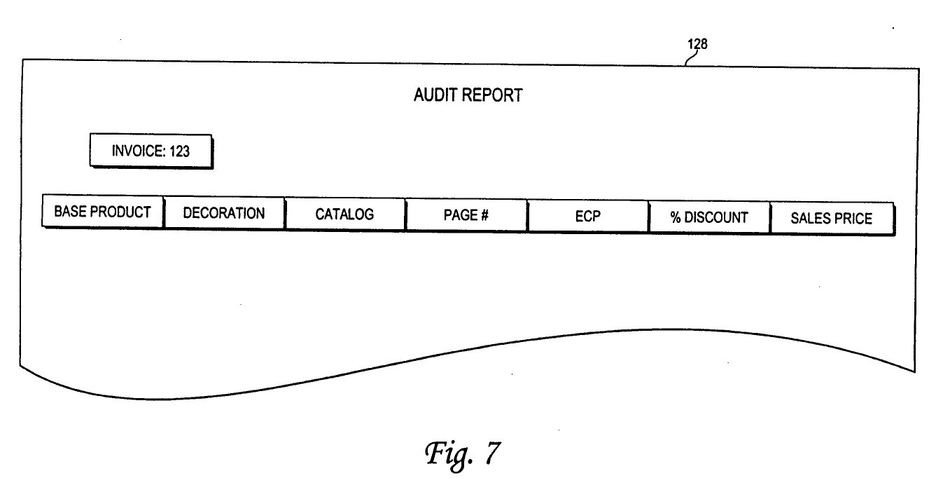

FIG. 7 is a diagrammatic representation of an audit report 128, according to an example embodiment of the present invention, that may be generated by a distributor 14 that operates the network-based distributor platform 25, and that may be supplied to a customer 16, so as to allow the customer conveniently to audit distributor compliance with a contract between the distributor 14 and the customer 16. The audit report 128, as illustrated, may include base product, decoration, catalog number, page number, ECP, percentage discount and purchase price information.

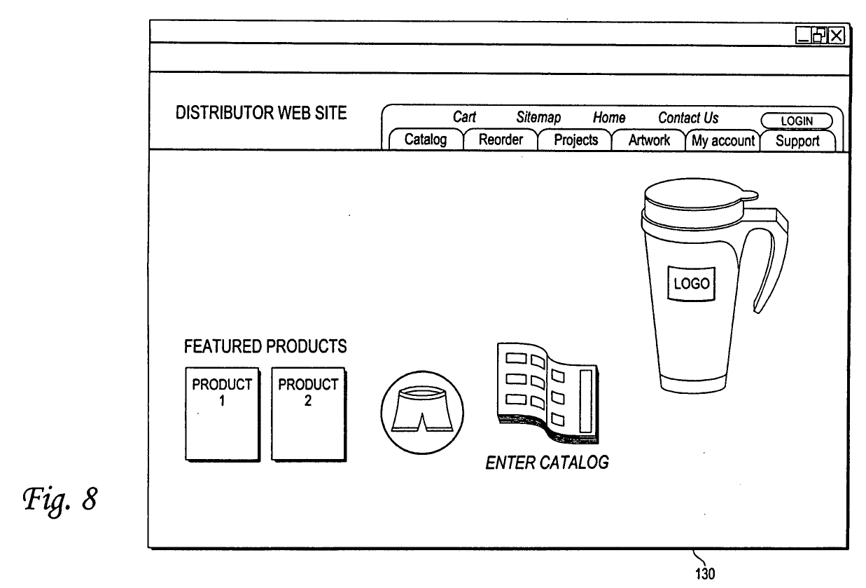

FIGS. 8-11 illustrate a series of user interfaces that the network-based distributor platform 25, via the web server 26, may communicate to a client machine 44 for display via a client application 46. In the example embodiment, the user interfaces illustrated in FIGS. 8-11 are HTML documents.

Turning to the first example user interface 130, illustrated in FIG. 8, multiple promotional products is presented to the user for selection. In the illustrated use scenario, user selection of the “boxers” promotional product occurs.

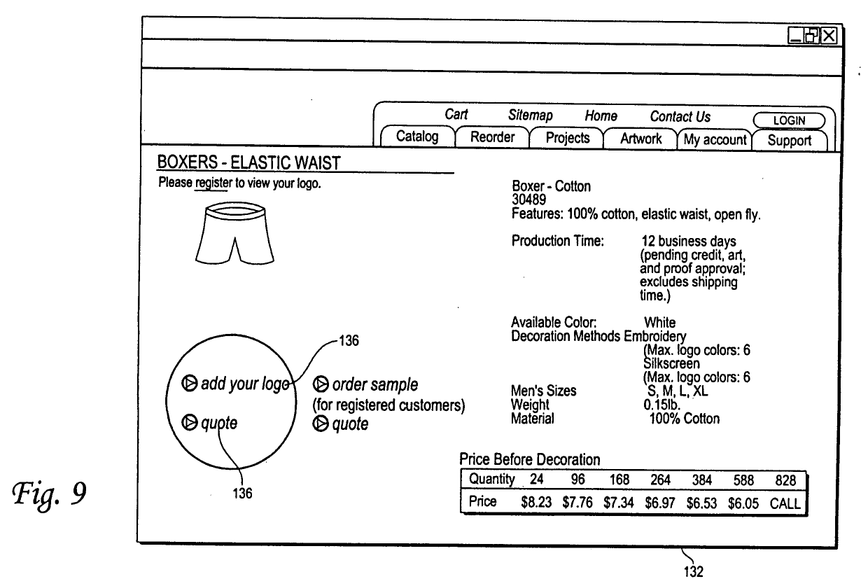

FIG. 9 illustrates an example user interface 132 that may be presented to a customer 16 responsive to the user selection that occurred within interface 130, as described above. Specifically, the user interface 132 provides further information regarding the selected promotional product (e.g., the boxers), and also provides a “quote” hypertext link 134, which is user selectable to request a purchase price from the network-based distributor platform 25. It will also be noted that the interface 132 provides an “add your logo” hypertext link 136, which is user selectable to invoke a flow whereby a consumer 16 may upload a digital representation of a logo to be used as the basis for a decoration to be applied to a selected base product (e.g., the boxers). In the scenario illustrated, it is assumed that a digital representation of a logo to be applied to the base product has already been uploaded.

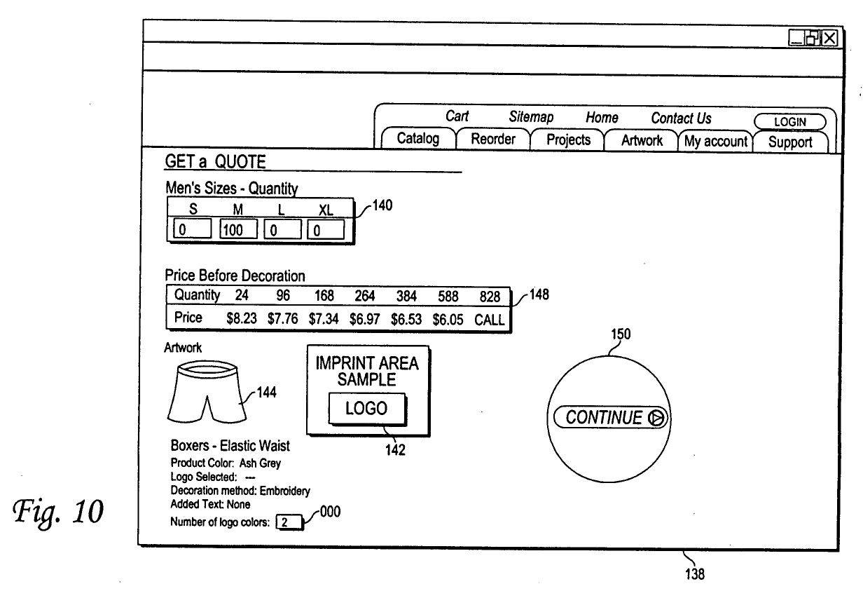

User selection of the “quote” hypertext link 134 illustrated in FIG. 9 results in the presentation of an example user interface 138, illustrated in FIG. 10. The interface 138 prompts the consumer 16 for quantity information 140, and provides graphic representations of (1) a decoration in the example form of a logo 142 and of (2) the base product 144. The consumer 16 may also be prompted for information regarding the number of logo colors at 146, and is also provided with details regarding logo size and decoration method. It will also be noted that the interface 138 also provides tiered base product pricing information 148, the pricing information 148, for example, having been calculated utilizing the operations described at blocks 108-112 of the method 100 illustrated in FIGS. 6A and 6B. The interface 138 also includes a “continue” hypertext link 150 to advance the example flow, and to cause generation and communication of a subsequent user interface.

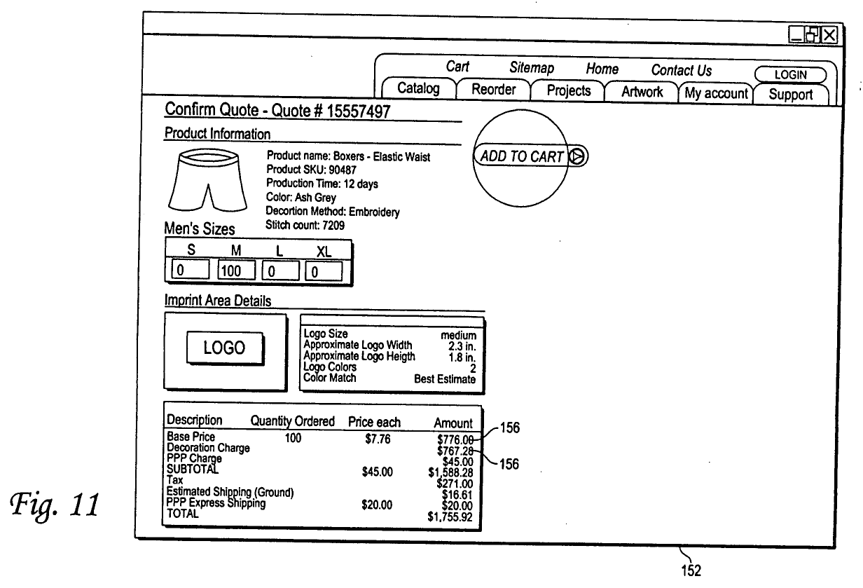

FIG. 11 illustrates a subsequent user interface 152 that, in addition to a base product purchase price 154, includes a decoration purchase price 156 that may be calculated utilizing the operations described above with reference to blocks 114-118 of the method 100 illustrated in FIG. 6. The interface 152 also provides descriptive information regarding the logo to be applied as the decoration to the base product and information regarding the base product itself, including a quantity communicated for the quote request.

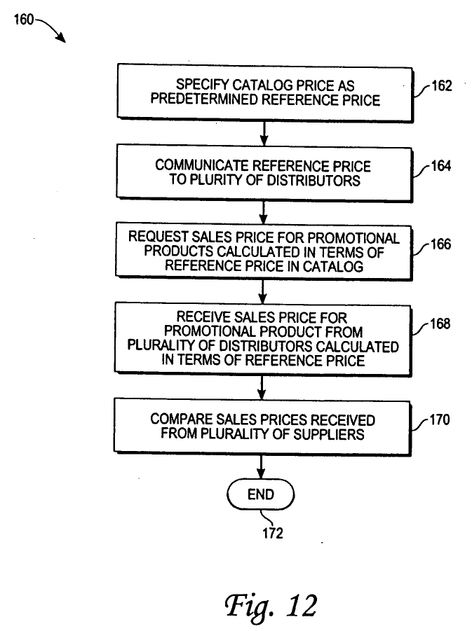

FIG. 12 is a flowchart illustrating the method 160, according to an example embodiment of the present invention, of comparing purchase prices from a plurality of distributors 14, these purchase prices having been calculated by each of the distributors 14 utilizing the method 100 described above, for example.

At block 162, the customer 16 specifies a catalog price as a predetermined reference pricing to be used in the calculation or determination of purchase prices by multiple distributors 14. In one example embodiment, the predetermined reference pricing may be specified to be the ECP 88 for each product, as published within a specific catalog, or within a collection of catalogs.

At block 164, the predetermined reference pricing specification is communicated from the customer 16, for example, to a plurality of distributors 14.

At block 166, the customer 16 requests purchase price information for promotional items from the multiple distributors 14. The requests include a requirement that the purchase price be calculated (or expressed) in terms of the predetermined reference pricing that was previously specified and communicated to the multiple distributors 14.

At block 168, the customer 16 receives purchase price information for one or more promotional items from each of the multiple distributors 14, the received purchase prices having been calculated utilizing the predetermined reference pricing.

At block 170, the customer 16 is able to compare the purchase prices, received from the multiple distributors 14, against each other, and make a meaningful comparison as each of the purchase prices would have been calculated based on the specified and predetermined reference purchase price. In this way, the customer 16 can identify whether one distributor is providing a more effective pricing than another.

The method 160 then terminates at block 172.

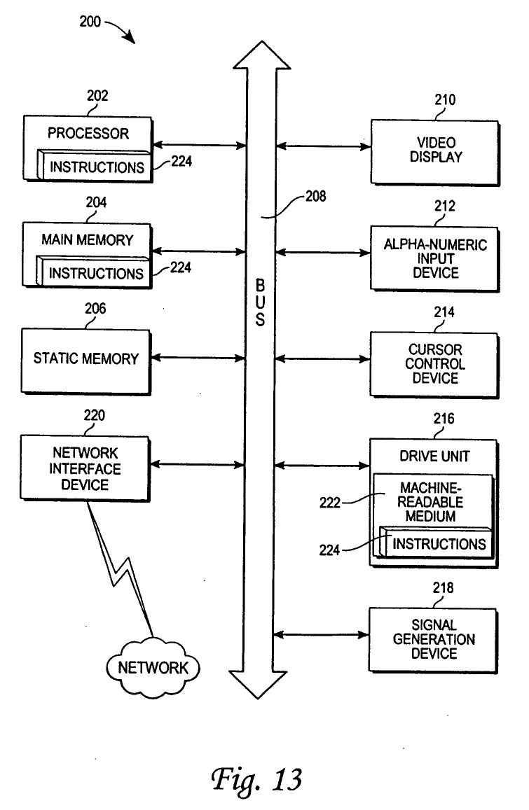

FIG. 13 shows a diagrammatic representation of machine in the example form of a computer system 200 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 200 includes a processor 202 (e.g., a central processing unit (CPU) a graphics processing unit (GPU) or both), a main memory 204 and a static memory 206, which communicate with each other via a bus 208. The computer system 200 may further include a video display unit 210 (e.g., a liquid crystal display (LCD) or a cathode ray tube (CRT)). The computer system 200 also includes an alphanumeric input device 212 (e.g., a keyboard), a user interface (UI) navigation device 214 (e.g., a mouse), a disk drive unit 216, a signal generation device 218 (e.g., a speaker) and a network interface device 220.

The disk drive unit 216 includes a machine-readable medium 222 on which is stored one or more sets of instructions (e.g., software 224) embodying any one or more of the methodologies or functions described herein. The software 224 may also reside, completely or at least partially, within the main memory 204 and/or within the processor 202 during execution thereof by the computer system 200, the main memory 204 and the processor 202 also constituting machine-readable media.

The software 224 may further be transmitted or received over a network 226 via the network interface device 220.

While the machine-readable medium 292 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to included, but not be limited to, solid-state memories, optical and magnetic media, and carrier wave signals.

Thus, a method and a system to calculate a purchase price automatically for a promotional product have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

1. A method to solicit bids for a promotional product from a plurality distributors, the method including:
providing an identifier for reference data to each of the plurality of distributors; and
requesting each of the plurality of distributors to provide a formula according to which a purchase price for the promotional product would be calculated, based on the reference data, at an unspecified future time.

2. The method of claim 1, wherein the identifier for the reference data is a promotional product catalog identifier.

3. A method automatically to calculate a purchase price for a promotional product, the method including:
in advance of a price calculation operation, electronically capturing reference data for the promotional product, and storing the reference data in a database, a source of the reference data having been identified and agreed to by a distributor and a customer, in advance of the capturing of the reference data;
in advance of the price calculation operation, electronically capturing a formula to calculate the purchase price based at least partially on the reference data, the formula having been identified and agreed to by the distributor and the customer, in advance of the capturing of the formula;
receiving, via a communications network, an electronic request for the purchase price for the promotional product from a requester; and
automatically calculating the purchase price for the promotional product utilizing the reference data and the formula.

4. The method of claim 3, wherein the reference data is a catalog price specified for the promotional product and the source is a catalog of a supplier of the promotional product.

5. The method of claim 3, including communicating, via the communications network, the purchase price for the promotional product to the requester.

6. The method of claim 3, wherein the capturing of the reference data includes electronically receiving catalog price information from the provider of the promotional product.

7. The method of claim 3, wherein the capturing of the reference data includes manually capturing price information from the catalog of the provider of the promotional product.

8. The method of claim 3 wherein the automatic calculation of the purchase price includes automatically accessing contract details, stored in a database, of the customer to determine the formula to calculate the purchase price based at least partially on the reference data, the formula being specific to the requester.

9. The method of claim 3, wherein the request includes quantity information indicating a quantity of the promotional product to which the request pertains, the automatic calculation of the purchase price including automatically referencing price tiering information, stored in the database, to identify the formula, from among a plurality of formulas, according to which the purchase price is calculated based on the reference data.

10. The method of claim 3, wherein the reference data is a base product price, and is an End Column Price (ECP) specified for a base product by the catalog.

11. The method of claim 1, wherein the reference data is a decoration price, and is specified in terms of a formula by the catalog.

12. The method of claim 11, wherein the formula includes any one of a group of variables including color and imprint variables.

13. The method of claim 12, wherein the formula includes a setup charge component and a running charge component.

14. The method of claim 3, wherein the request includes visual product specifications from which information regarding the promotional product is extracted.

15. The method of claim 3, including providing an audit report to the requester, the audit report indicating, for each of a plurality of completed purchases, and the ECP, and catalog information identifying a location in the catalog at which the ECP is located.

16. A system to calculate a purchase price for a promotional product, the system including:
a capture engine electronically to capture reference data for the promotional product, and to store the reference data in a database;
an interface to receive, via a communications network, an electronic request for a purchase price for the promotional product from a requester; and
a pricing engine automatically to calculate the purchase price for the promotional product based on the reference data.

17. The system of claim 16, wherein the reference data comprises a catalog price specified for the promotional product by a catalog of a provider of the promotional product.

18. The system of claim 16, wherein the interface is to communicate, via the communications network, the purchase price for the promotional product to the requester.

19. The system of claim 17, wherein the capture engine is electronically to receive catalog price information from the provider of the promotional product.

20. The system of claim 17, wherein the capture engine is to facilitate manual input of catalog price information from the catalog of the provider of the promotional product.

21. The system of claim 16, wherein the pricing engine is to calculate the purchase price automatically by accessing contract details, stored in a database, of the requester to determine a formula according to which the purchase price is a calculated based on the reference data, the formula being specific to the requester.

22. The system of claim 16, wherein the request includes quantity information indicating a quantity of the promotional product to which the request pertains, the pricing engine to calculate the purchase price automatically by referencing price tiering information, stored in the database, to determine a formula according to which the purchase price is a calculated based on the reference data.

23. The method of claim 17, wherein the catalog price is a base product price, and is an End Column Price (ECP) specified for a base product by the catalog.

24. The system of claim 17, wherein the catalog price is a decoration price, and is specified in terms of a formula by the catalog.

25. The system of claim 24, wherein the formula includes any one of a group of variables including color and imprint variables.

26. The system of claim 24, wherein the formula includes a setup charge component and a running charge component.

27. The system of claim 16, wherein the electronic request includes visual product specifications from which information regarding the promotional product is extracted.

28. The system of claim 16, wherein the pricing engine is to provide an audit report to the requester, the audit report indicating, for each of a plurality of completed purchases, and the ECP, and catalog information identifying a location in the catalog at which the ECP is located.

29. A machine-readable medium storing a set of instructions that, when executed by a machine, cause the machine to:
electronically store reference data for the promotional product in a database;
receive, via a communications network, an electronic request for a purchase price for the promotional product from a requester; and
automatically calculate the purchase price for the promotional product utilizing a formula according to which the purchase price is a calculated based on the reference data.

30. A system to calculate a purchase price for a promotional product, the system including:
first means for electronically capturing reference data for the promotional product, and for storing the reference data in a database;
second means for receiving, via a communications network, an electronic request for a purchase price for the promotional product from a requester; and
third means for automatically calculating the purchase price for the promotional product based on the reference data.

31. A method to establish an agreement regarding a purchase price for a promotional product to be purchased at a future date, the method including:
identifying a source from which reference data for the promotional product will be determinable at the future date;
specifying a purchase price for the promotional product based on the reference data as determinable from the source at the future date; and
communicating the specification of the purchase price for the promotional product, based on the reference data, to a third party.

32. The method of claim 31, wherein the specification of the purchase price is as a percentage of a reference price specified by the reference data, as determinable from the source at the future date.

33. The method of claim 31, wherein the identification of the source does not include identification of the promotional product.

34. The method of claim 31, including, at the third party, receiving a plurality of specifications of purchase prices from a plurality of distributors of promotional products, wherein each of the plurality of specifications is based on the reference data, as determinable from the source at the future date.
